(19) United States
(12) Patent Application Publication
(10) Pub. No.: US 2017/0015036 A1
(43) Pub. Date: Jan. 19, 2017

(54) INJECTION MOLDING METHOD, SCREW, AND INJECTION MOLDING MACHINE

(71) Applicant: MITSUBISHI HEAVY INDUSTRIES PLASTIC TECHNOLOGY CO., LTD., Nagoya-shi (JP)

(72) Inventors: Toshihiko KARIYA, Aichi (JP); Munehiro NOBUTA, Aichi (JP); Naoki TODA, Aichi (JP); Kiyoshi KINOSHITA, Aichi (JP); Takeshi YAMAGUCHI, Aichi (JP)

(21) Appl. No.: 15/115,255

(22) PCT Filed: May 30, 2014
(86) PCT No.: PCT/JP2014/002887

§ 371 Date: Jul. 28, 2016

(51) Int. Cl. B29C 45/60; B29C 45/50; B29C 45/00

(52) U.S. Cl. CPC B29C 45/60; B29C 45/0005; B29C 45/50; B29K 2105/12

(57) ABSTRACT

In an injection molding method of fiber reinforced resin of the present invention, a resin accumulation region is provided closer to a downstream side than an injection completion position inside a heating cylinder, an injection pressure is given to molten resin that occupies the resin accumulation region in an injection process of a preceding cycle, and a shear force is given to the molten resin that occupies the resin accumulation region in a plasticizing process of a subsequent cycle. An inside of massive reinforcing fibers F is impregnated with the molten resin by giving a high injection pressure to the molten resin that occupies the resin accumulation region. Next, dispersion of the reinforcing fibers is promoted by giving a shear force in the plasticizing process of the subsequent cycle.

### TECHNICAL FIELD

The present invention relates to injection molding of resin containing reinforcing fibers.

### BACKGROUND ART

There have been used for various applications molded products of fiber reinforced resin in which strength have been enhanced by making them contain reinforcing fibers. As a technique to obtain the molded product by injection molding, a technique has been known in which thermoplastic resin is melted by rotation of a screw in a cylinder serving as a plasticizing device, fibers are mixed in or kneaded with the melted thermoplastic resin, and subsequently, the thermoplastic resin is injected into a mold of an injection molding machine.

In order to obtain an effect of improving strength by reinforcing fibers, the reinforcing fibers are desired to be uniformly dispersed in resin. Although mixing conditions may just be made severe to strengthen a shear force given to reinforcing fibers in order to achieve uniform dispersion, an excessively strong shear force causes cutting of the reinforcing fibers. In that case, a fiber length after molding might be significantly shorter than an original fiber length, and obtained molded products cannot possibly satisfy desired characteristics (Patent Literature 1). Accordingly, it becomes necessary to select conditions of injection molding in which the shear force is weakened so that breakage of the fibers does not occur at the time of mixing. In that case, the reinforcing fibers cannot be uniformly dispersed in fiber reinforced resin, and are unevenly distributed. Although a mechanism (a feeder) that forcibly feeds the reinforcing fibers inside the cylinder is also provided in order to contribute to uniform dispersion of the reinforcing fibers (for example, Patent Literature 2), a mass of the reinforcing fibers has not been eliminated yet. Particularly, in a case where a contained amount of the reinforcing fibers is high, i.e. not less than 10%, it is difficult to uniformly disperse the reinforcing fibers in the resin.

### CITATION LIST

### Patent Literature

Patent Literature 1: Japanese Patent Laid-Open No. 2012-56173

Patent Literature 2: Japanese Patent Laid-Open No. 2012-511445

### SUMMARY OF INVENTION

### Technical Problem

The present invention aims to provide an injection molding method of fiber reinforced resin that can eliminate uneven distribution of reinforcing fibers without giving an excessive shear force to the reinforcing fibers.

In addition, the present invention aims to provide a screw suitable for carrying out such an injection molding method.

Further, the present invention aims to provide an injection molding machine suitable for carrying out such an injection molding method.

### Solution to Problem

The present inventors examined a cause of uneven distribution of reinforcing fibers, and obtained one conclusion. That is, during a plasticizing process of injection molding, as shown in FIG. 5, a fiber mass, which is a set of a number of reinforcing fibers F, and molten resin M are present in a screw groove 301 between flights 306 of a screw 300 arranged inside a cylinder 310, the fiber mass and the molten resin M being separated into a pull side 303 and a push side 305 of the flight. Since a viscosity of the molten resin M is relatively high, and the molten resin M cannot get into the fiber mass, a shear force by rotation of the screw 300 through a medium of the molten resin M is not transmitted to an inside of the fiber mass, and opening of the fiber mass does not proceed. Accordingly, since the reinforcing fibers F are injected while remaining as the fiber mass, they are unevenly distributed in a molded product. Note that a white arrow of FIG. 5A shows a direction in which the screw 300 rotates, and that white arrows of FIG. 5C show relative moving directions of the screw 300 and the cylinder 310 in an axial direction or in a peripheral direction along with the rotation of the screw 300. The same applies to an embodiment, which will be mentioned later.

The present inventors have conceived of an idea in which in an injection process, an inside of the fiber mass including the reinforcing fibers F is impregnated with the molten resin M utilizing an extremely high pressure being given to the molten resin M. However, since the reinforcing fibers F cannot be sufficiently opened to be dispersed only by the impregnation, opening of the reinforcing fibers F is promoted by giving the shear force to the reinforcing fibers F through the molten resin M after the impregnation.

Namely, the present invention relates to an injection molding method of fiber reinforced resin that repeats: a plasticizing process of feeding a resin raw material and reinforcing fibers to a cylinder inside which a screw is provided, melting the resin raw material by rotating the screw, and generating molten resin containing the reinforcing fibers; and an injection process of discharging from the cylinder a predetermined amount of molten resin containing the reinforcing fibers by advancing the screw to a predetermined injection completion position to give a predetermined injection pressure.

In the injection molding method of the present invention, a resin accumulation region is provided in a region to which the injection pressure inside the cylinder is applied, the injection pressure is given to the molten resin that occupies the resin accumulation region in the injection process of a preceding cycle, and a shear force is given to the molten resin that occupies the resin accumulation region in the plasticizing process of a subsequent cycle.

Note that a term of the upstream or the downstream used herein shall be used on the basis of a direction in which the resin is conveyed by the screw.

The present invention is preferably applied to an injection molding method in which the reinforcing fibers are fed to the cylinder closer to a downstream side than the resin raw material is.

In the injection molding method of the present invention, the shear force in the plasticizing process of the subsequent cycle is preferably given by a shear giving shaft rotating along with rotation of the screw, the shear giving shaft being provided coaxially with the screw and extending in the resin accumulation region.

In the injection molding method of the present invention, the screw includes: a first stage at which the fed resin raw material is melted; a second stage continuing to the first stage, at which the melted resin raw material and the reinforcing fibers are mixed with each other; and a third stage that continues to the second stage through a backflow prevention portion, and the third stage preferably includes the shear giving shaft that gives the shear force to the molten resin that occupies the resin accumulation region by rotating along with the rotation of the screw.

The shear giving shaft of the third stage preferably includes one or both of a spiral flight that projects in a radial direction from an outer peripheral surface, and a mixing at which a plurality of fins that project in a radial direction from an outer peripheral surface have been aligned in a peripheral direction.

The present invention provides the following screw suitably applied to the injection molding method explained in the above.

The screw is provided inside a cylinder of an injection molding machine to which a resin raw material is fed on an upstream side in a conveyance direction of resin and to which reinforcing fibers are fed on a downstream side therein, and includes: a first stage at which the fed resin raw material is melted; a second stage that continues to the first stage, and at which the melted resin raw material and the reinforcing fibers to be fed are mixed with each other; and a third stage that continues to the second stage through a backflow prevention portion, and includes a shear giving shaft that gives a shear force to molten resin that occupies surroundings of the screw by rotating along with rotation of the screw.

The present invention provides the following injection molding machine suitably applied to the injection molding method explained in the above.

The injection molding machine includes: a cylinder at which a discharge nozzle has been formed; a screw provided rotatable and movable in a rotation axis direction inside the cylinder; a resin feed portion that feeds a resin raw material in the cylinder; and a fiber feed portion that is provided closer to a downstream side than the resin feed portion, and feeds reinforcing fibers in the cylinder.

The screw used for the injection molding machine includes: a first stage at which the resin raw material to be fed is melted; a second stage that continues to the first stage, and at which the melted resin raw material and the fed reinforcing fibers are mixed with each other; and a third stage that continues to the second stage through a backflow prevention portion, and includes a shear giving shaft that gives a shear force to molten resin that occupies surroundings of the screw by rotating along with rotation of the screw.

### Advantageous Effects of Invention

According to the present invention, there can be provided the screw of the injection molding machine that can eliminate uneven distribution of the reinforcing fibers without giving an excessive shear force to the reinforcing fibers.

### BRIEF DESCRIPTION OF DRAWINGS

FIG. 1 is a view showing a schematic configuration of an injection molding machine according to the embodiment.

FIGS. 2A to 2C are views schematically showing molten states of resin in respective procedures of injection molding according to the embodiment: FIG. 2A shows the molten state at the time of plasticization start; FIG. 2B at the time of plasticization completion; and FIG. 3C at the time of injection completion.

FIGS. 3A to 3C are views showing a screw according to the embodiment: FIG. 3A is a side view showing main portions of a second stage and a third stage; FIG. 3B shows that a fiber mass including reinforcing fibers F is impregnated with surrounding molten resin M at the time of an injection process; and FIG. 3C shows that the reinforcing fibers F are dispersed by giving a shear force after the impregnation.

FIGS. 4A to 4F are views showing various modes of the third stage according to the embodiment.

FIGS. 5A to 5C show a conventional screw: FIG. 5A is a side view showing a main portion of a second stage; FIG. 5B is a cross-sectional view showing a screw groove formed by flights, and a vicinity of the screw groove; and FIG. 5C is a cross-sectional view schematically showing that a mass of reinforcing fibers and a mass of molten resin are separately present inside the screw groove.

### DESCRIPTION OF EMBODIMENT

Hereinafter, the present invention will be explained in detail based on an embodiment shown in accompanying drawings.

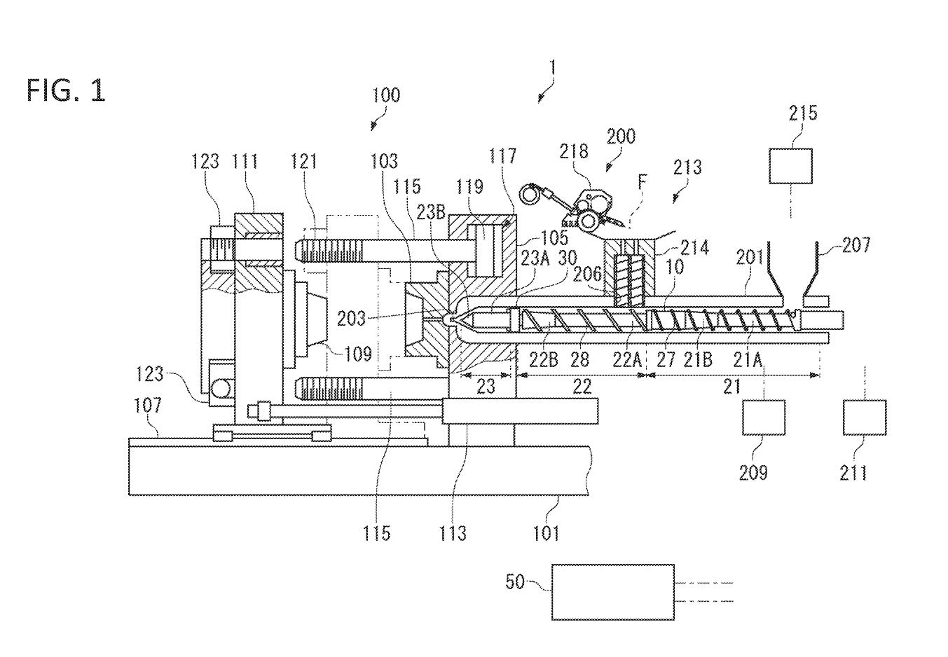

An injection molding machine 1 according to the embodiment, as shown in FIG. 1, includes: a mold clamping unit 100; a plasticizing unit 200; and a control unit 50 that controls operations of the units.

Hereinafter, outlines of a configuration and the operation of the mold clamping unit 100, and a configuration and the operation of the plasticizing unit 200 will be explained, and next, procedures of injection molding by the injection molding machine 1 will be explained.

### [Configuration of Mold Clamping Unit]

The mold clamping unit 100 includes: a fixed die plate 105 that has been fixed on a base frame 101 and to which a fixed mold 103 has been attached; a movable die plate 111 that moves on a slide member 107, such as a rail and a slide plate in a left and right direction in FIG. 1 by actuating a hydraulic cylinder 113, and to which a movable mold 109 has been attached; and a plurality of tie bars 115 that couple the fixed die plate 105 with the movable die plate 111. At the fixed die plate 105, a hydraulic cylinder 117 for mold clamping is provided coaxially with each tie bar 115, and one end of the each tie bar 115 is connected to a ram 119 of the hydraulic cylinder 117.

Each of the components performs a necessary operation in accordance with an instruction of the control unit 50.

### [Operation of Mold Clamping Unit]

A rough operation of the mold clamping unit 100 is as follows.

First, the movable die plate 111 is moved to a position of a chain double-dashed line in FIG. 1 by actuation of the hydraulic cylinder 113 for mold opening and closing to thereby make the movable mold 109 abut against the fixed mold 103. Next, a male screw portion 121 of each tie bar 115 and a half nut 123 provided at the movable die plate 111 are engaged with each other to thereby fix the movable die plate 111 to the tie bars 115. Subsequently, a pressure of hydraulic oil of an oil chamber of a movable die plate 111 side in the hydraulic cylinder 117 is increased to thereby clamp the fixed mold 103 and the movable mold 109. After mold clamping is performed in a manner as described above, molten resin M is injected from the plasticizing unit 200 into a cavity of the mold to then form a molded product.

Since the screw 10 of the embodiment, as will be mentioned later, has a system that individually feeds a thermoplastic resin pellet P and reinforcing fibers F in a longitudinal direction of the screw, an entire length of the screw 10 or an entire length of the plasticizing unit 200 tends to be long. For this reason, in the embodiment, combining the mold clamping unit 100 having the above-mentioned configuration that can save a space is effective for suppressing an entire length of the injection molding machine 1 to be short, the mold clamping unit 100 being able to be installed even in a narrow space in which a mold clamping apparatus of a toggle link system or a system including a mold clamping cylinder at a back surface of a movable die plate cannot be installed. However, the configuration of the mold clamping unit 100 shown here is merely one example, and it does not prevent application of or replacement with the other configuration. For example, although the hydraulic cylinder 113 is shown as an actuator for mold opening and closing in the embodiment, it may be replaced with a combination of a mechanism that converts a rotational motion into a linear motion, and an electric motor, such as a servomotor and an induction motor. As the conversion mechanism, a ball screw and a rack and pinion can be used. In addition, it is needless to say that the mold clamping unit 100 may be replaced with a toggle link type mold clamping unit by electric drive or hydraulic drive.

### [Configuration of Plasticizing Unit]

The plasticizing unit 200 includes: a cylindrical heating cylinder 201; a discharge nozzle 203 provided at a downstream end of the heating cylinder 201; the screw 10 provided inside the heating cylinder 201; a fiber feed device 213 to which the reinforcing fibers F are fed; and a resin feed hopper 207 to which the resin pellet P is fed. The fiber feed device 213 is coupled with a vent hole 206 provided closer to the downstream side than the resin feed hopper 207.

The plasticizing unit 200 includes: a first electric motor 209 that advances or retreats the screw 10; a second electric motor 211 that rotates the screw 10 in a normal or a reverse direction; and a pellet feed device 215 that feeds the resin pellet P to the resin feed hopper 207. Each of the components performs a necessary operation in accordance with an instruction of the control unit 50.

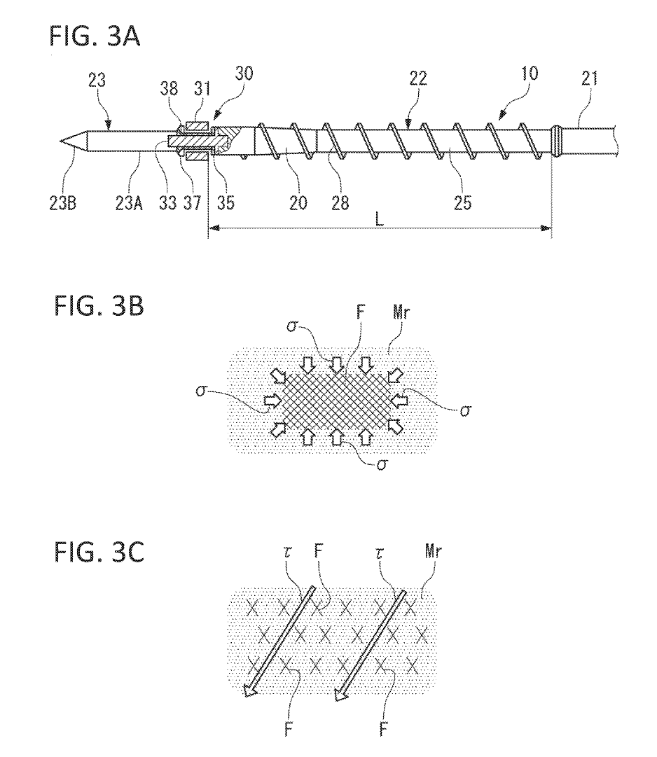

As shown in FIGS. 1 and 3A, an unprecedented new stage (a third stage 23) is added to the screw 10 while following a two-stage type design similar to a so-called gas vent type screw. Specifically, the screw 10 includes: a first stage 21 provided on an upstream side; a second stage 22 that continues to the first stage 21 and is provided on the downstream side; and the third stage 23 that continues to the second stage 22 and is provided on the downstream side.

The first stage 21 includes a feed portion 21A, a compression portion 21B, and a measurement portion 21C in that order from the upstream side, and the second stage 22 includes a feed portion 22A and a compression portion 22B in that order from the upstream side. However, on the downstream side of the compression portion 22B, a not-shown measurement portion may be provided coupled to the compression portion 22B. Note that a right side in FIG. 1 is the upstream side, and that a left side therein is the downstream side. The same applies to an embodiment, which will be mentioned later. The third stage 23 includes: a cylindrical shear giving shaft 23A; and a triangular pyramid-shaped screw chip 23B provided at a tip of the shear giving shaft 23A. However, the cylindrical shear giving shaft 23A is just one example, and the present invention can employ various modes of shear giving shafts as will be mentioned later.

In the screw 10, a first flight 27 is provided at the first stage 21, and a second flight 28 is provided at the second stage 22.

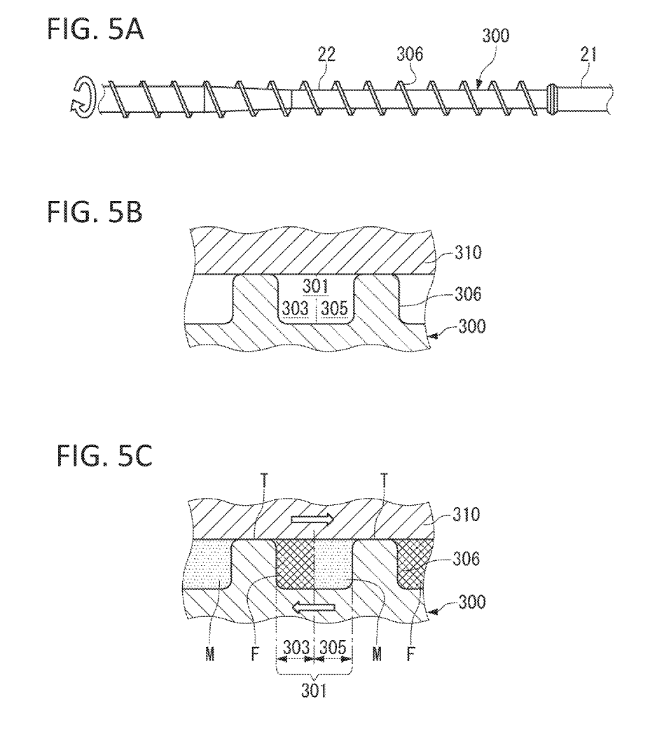

In both of the first stage 21 and the second stage 22, relatively, screw grooves between the flights in the feed portions 21A and 22A are set to be deep, screw grooves between the flights of the compression portions 21B and 22B are set to gradually decrease from the upstream side toward the downstream side, and screw groove in the measurement portion 21C is set to be the most shallow. Here, since the screw groove of the feed portion 22A of the second stage 22 is deeper than that of the measurement portion 21C of the first stage 21, the molten resin M discharged from the first stage 21 to the feed portion 22A cannot fill the screw groove of the compression portion 22B. Hereby, the molten resin M is pushed against the push side 305 by rotation of the screw 10, and is unevenly distributed. Hereby, a space is generated on the pull side 303 of the feed portion 25 of the second stage 22. For this reason, it is understood that the reinforcing fibers F fed from the fiber feed device 213 through the vent hole 206 are distributed to the pull side 303 serving as the space, and that thereby the molten resin M and the reinforcing fibers F are divided as shown in FIG. 5.

Since the first stage 21 conveys the generated molten resin M toward the second stage 22 in addition to melting a resin raw material to thereby generate the molten resin M, it may just include a function to secure a conveyance velocity and plasticizing capacity of the molten resin M.

In order to obtain the function, as shown in FIG. 1, it is preferable that a flight lead (L1) of the first flight 27 of the first stage 21 is not more than a flight lead (L2) of the second flight 28 of the second stage 22, i.e. L1≦L2 is established. Note that the flight lead (hereinafter simply referred to as a lead) means an interval between flights at the front and rear. As one index, the lead L1 of the first flight 27 is preferably set to be 0.4 to 1.0 times of the lead L2, and is more preferably set to be 0.5 to 0.9 times thereof.

According to the above-mentioned preferred mode in which L1≦L2 is established, the lead L2 of the second flight 28 of the second stage 22 is larger than the lead L1 of the first flight 27. The reinforcing fibers F are fed to a rear end side of the second stage 22 during the plasticizing process. When the lead L2 is large, a groove width between the second flights 28 is large, the reinforcing fibers F drop, and a space to be able to be filled becomes large. In addition to that, the number of times decreases that the vent hole 206 is blocked by the second flight 28 at the time of retreat of the screw 10 in the plasticizing process, and at the time of advance of the screw 10 in an injection process. Accordingly, even during the retreat or the advance of the screw 10, the drop of the reinforcing fibers F is not stopped at the second flight 28, and the reinforcing fibers F easily continuously drop in the groove. Specifically, in a region of the second flight 28 in which the reinforcing fibers F fed through the vent hole 206 are received, the lead L2 is preferably set to be not less than 1.0×D, and is more preferably set to be not less than 1.2×D. Thereby, the reinforcing fibers F can be stably dropped in the groove of the screw 10 during the injection process. Note that D is an inner diameter of the heating cylinder 201.

However, when the lead L2 becomes too large, a force of conveying the molten resin M becomes weak, conveyance of the molten resin M becomes unstable even at an extent of a back pressure (5 to 10 MPa) required for usual plasticization, the molten resin M due to the back pressure flows backward to the vent hole 206, and vent-up easily occurs. Accordingly, the lead L2 is preferably set to be not more than 2.0×D, and is more preferably set to be not more than 1.7×D. That is, the lead L2 of the second flight 28 is preferably set to be 1.0×D to 2.0×D, and is more preferably set to be 1.2×D to 1.7×D.

In addition, a width of the flight of the second flight 28 is preferably set to be 0.01 to 0.3 times (0.01×L2 to 0.3 ×L2) of the lead L2. This is because when the width of the flight is smaller than 0.01 times of the lead L2, strength of the second flight 28 becomes insufficient, and because when the width of the flight exceeds 0.3 times of the lead L2, a screw groove width becomes small, and the fibers are caught in a flight top to thereby be hard to drop in the groove.

A backflow prevention portion 30 is provided between the second stage 22 and the third stage 23 as shown in FIG. 3A. Although the backflow prevention portion 30 allows the molten resin M to flow from the second stage 22 toward the third stage 23, it is a mechanism that prevents the molten resin M from flowing backward, and includes a check ring 31 as a major component.

The molten resin M is made to flow into the third stage 23 through the backflow prevention portion 30 during the plasticizing process, and is injected into the cavity formed between the fixed mold 103 and the movable mold 109 while inflow to the second stage 22 is prevented by the backflow prevention portion 30 during the injection process.

In the present invention, a configuration of the backflow prevention portion 30 is arbitrary, and can be selected from various types, such as a ring type and a ball check type. The embodiment employs the ring type, and explanation of a rough configuration and operation thereof is as follows.

The check ring 31 is located around a coupling shaft 33 that connects the second stage 22 and the third stage 23, and is provided movable in an axial direction. The check ring 31 is made to abut against a first sheet ring 37 provided on the downstream side during the plasticizing process. Since a flow passage 38 is formed in the first sheet ring 37 by being notched in a surface facing the check ring 31, the molten resin M is conveyed to the third stage 23, passing through a gap between the check ring 31 and the second sheet ring 35, a gap between the check ring 31 and the coupling shaft 33, and the flow passage 38 in that order. Meanwhile, when the injection process is started, the flow passage of the molten resin M is closed by the check ring 31 abutting against a second sheet ring 35 of the upstream side, and the check ring 31 prevents the backflow of the molten resin M.

Next, the third stage 23 is arranged on the downstream side to which a high injection pressure is given during the injection process, and generates a swirling flow in the molten resin M by rotating to thereby give a shear force. Note that it is a point closer to the downstream side than the backflow prevention portion 30, i.e. the molten resin M present between the third stage 23 and the heating cylinder 201 that the high pressure is given.

Although the third stage 23 is not restricted as long as it can achieve a function to give the shear force, a volume of the downstream side from the backflow prevention portion 30 becomes small in the inside of the heating cylinder 201 when a size of the third stage 23 in the axial direction is short. Accordingly, since an amount of the molten resin M in which treatment of impregnation and shear giving can be performed at a time is decreased, a size and a shape of the third stage 23, particularly of the shear giving shaft 23A are set in consideration of the treatment amount. In addition to that, a volume V between an inside surface of the heating cylinder 201 and an outside surface of the shear giving shaft 23A is preferably set so as to satisfy the following Expression (1). In Expression (1), a reference character S denotes a cross-sectional area in an inner diameter of the heating cylinder 201, and a reference character L a length (refer to FIG. 3A) of the second stage 22.

V=( 1/20)×L×S to (½)×L×S (1)

A shear amount in the shear giving shaft 23A portion is largely affected not only by the number of rotation of the screw 10 but a time and a distance for the molten resin M to pass through a portion in which the shear giving shaft 23A is provided. The passing time is affected by a conveyance velocity of the molten resin M that passes through the shear giving shaft 23A, and the passing distance is affected by a length of the shear giving shaft 23A. Note that in a case where the shear giving shaft 23A includes a flight as will be mentioned later, the passing distance is affected also by a flight lead in addition to the length of the shear giving shaft 23A. Particularly, when the volume V between the inside surface of the heating cylinder 201 and the outside surface of the shear giving shaft 23A (for example, a flow passage cross-sectional area of the molten resin M between the inside surface of the heating cylinder 201 and the outside surface of the shear giving shaft 23A) is small, the conveyance velocity of the molten resin M that has flowed into the portion in which the shear giving shaft 23A is provided from the second stage 22 is increased. At this time, since the time for the molten resin M to pass through the portion in which the shear giving shaft 23A is provided becomes short, a time for the molten resin M to receive the shear force from the rotation of the screw 10 during the passing of the molten resin M becomes short. At this time, when the volume V is smaller than ( 1/20)×L×S, a sufficient shear amount cannot be given by the shear giving shaft 23A with respect to a shear amount applied to a reinforcing fiber mass at the second stage. Conversely, when the volume V between the inside surface of the heating cylinder 201 and the outside surfaces of the shear giving shaft 23A is large, the conveyance velocity of the molten resin M that has flowed into the portion in which the shear giving shaft 23A is provided from the second stage 22 is decreased. In this case, since the time for the molten resin M to pass through the portion in which the shear giving shaft 23A is provided becomes long, a time for the molten resin M to receive the shear force from the rotation of the screw 10 during the passing of the molten resin M becomes long. At this time, when V is larger than (½)×L×S, a shear amount given together with the shear amount applied to the reinforcing fiber mass at the second stage becomes excessive, and breakage of the reinforcing fibers F is large.

According to the above, the volume V preferably follows Expression (2), and more preferably follows Expression (3).

V=( 1/15)×L×S to ( 3/7)×L×S (2)

V=( 1/10)×L×S to (⅖)×L×S (3)

In the fiber feed device 213 of the embodiment, a biaxial type screw feeder 214 is provided at the heating cylinder 201 as shown in FIG. 1, and the reinforcing fibers F are forcibly fed in the groove of the screw 10. Note that it is needless to say that there is no problem if a uniaxial type screw feeder is used.

As a method of feeding the reinforcing fibers F to the biaxial type screw feeder 214, continuous fibers, so-called fibers in a roving state (hereinafter referred to as roving fibers) may be directly put in the biaxial type screw feeder 214, or fibers in a chopped strand state (hereinafter referred to as chopped fibers) may be put therein, the fibers being previously cut to have a predetermined length. Alternatively, the roving fibers and the chopped fibers may be mixed and put in the biaxial type screw feeder 214 at a predetermined ratio.

In a case where the chopped fibers are put in the biaxial type screw feeder 214, the roving fibers may be conveyed near a fiber inlet of a measurement feeder as they are, and may be put in the above-described measurement feeder immediately after being cut near the fiber inlet. Hereby, since the chopped fibers likely to be scattered are not exposed before being put in the molding machine, workability can be improved.

In the embodiment, a roving cutter 218 is provided near the fiber inlet of the biaxial type screw feeder 214. The roving fibers are cut by the roving cutter 218 to thereby be made into the chopped fibers, and then, they are fed to the biaxial type screw feeder 214.

### [Operation of Plasticizing Unit]

A rough operation of the plasticizing unit 200 is as follows. Note that, please refer to FIG. 1.

When the screw 10 provided inside the heating cylinder 201 is rotated, a pellet (the resin pellet P) including the reinforcing fibers F fed from the fiber feed device 213 through the vent hole 206, and thermoplastic resin fed from the resin feed hopper 207 is sent out toward the discharge nozzle 203 of the downstream end of the heating cylinder 201. Note that timing to start the feed of the reinforcing fibers F is preferably set to be a timing after the resin pellet P (the molten resin M) fed from the resin feed hopper 207 reaches the vent hole 206 through which the reinforcing fibers F are fed. When the reinforcing fibers F are started to be put in before the molten resin M reaches the vent hole 206, the reinforcing fibers F poor in flowability, and conveyability by the screw 10 block the inside of the screw groove, thereby the molten resin M might be prevented from being conveyed to overflow the vent hole 206, or abnormal wear and breakage of the screw 10 might occur. After the molten resin M is mixed with the reinforcing fibers F, only a predetermined amount of the molten resin M is injected to the cavity formed between the fixed mold 103 and the movable mold 109 of the mold clamping unit 100. Note that it is needless to say that a basic operation of the screw 10 in which injection is performed by advance of the screw 10 follows after the screw 10 retreats while receiving the back pressure along with melting of the resin pellet P. In addition, the present invention does not prevent applying or being replaced with the other configuration, such as providing a heater outside the heating cylinder 201 in order to melt the resin pellet P.

### [Procedure of Injection Molding]

The injection molding machine 1 including the above components performs injection molding in the following procedures.

Injection molding, as is known well, includes: a mold clamping process of closing the movable mold 109 and the fixed mold 103, and clamping them with a high pressure; a plasticizing process of heating, melting, and plasticizing the resin pellet P in the heating cylinder 201; an injection process of injecting the plasticized molten resin M to the cavity formed by the movable mold 109 and the fixed mold 103, and filling the cavity with the plasticized molten resin M; a holding process of cooling the molten resin M with which the cavity has been filled until it is solidified; a mold opening process of opening the mold; and a taking-out process of taking out a molded product cooled and solidified in the cavity. The above-mentioned respective processes are sequentially carried out, or a part of them is concurrently carried out, and the one-cycle injection molding is completed.

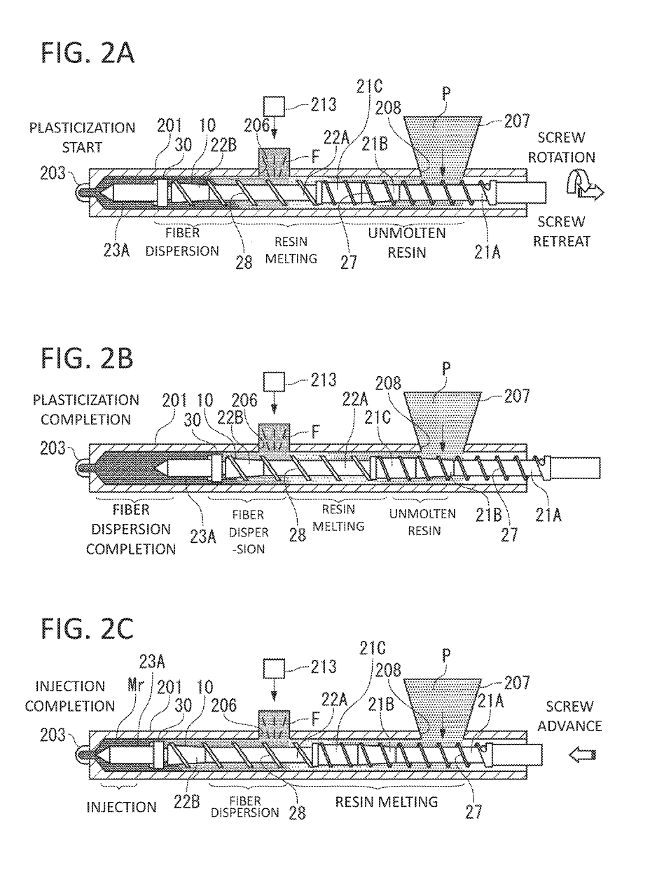

Subsequently, the plasticizing process and the injection process to which the present invention is related will be explained in that order with reference to FIGS. 2A to 2C.

### [Plasticizing Process]

In the plasticizing process, the resin pellet P is fed through a feed hole 208 corresponding to the resin feed hopper 207 of the back of the heating cylinder 201. The screw 10 at the time of plasticization start is located on the downstream of the heating cylinder 201, and it is retreated from an initial position while being rotated (“plasticization start” in FIG. 2A). By rotating the screw 10, the resin pellet P fed between the screw 10 and the heating cylinder 201 is gradually melted while being heated by receiving a shear force, and is conveyed toward the downstream. Note that rotation (a direction) of the screw 10 in the plasticizing process is set to be a normal rotation in the present invention. If the molten resin M is conveyed to the fiber feed device 213, the reinforcing fibers F are fed from the fiber feed device 213. Along with the rotation of the screw 10, the reinforcing fibers F are kneaded with and dispersed in the molten resin M, and are conveyed to the downstream together with the molten resin M. When feed of the resin pellet P and the reinforcing fibers F is continued, and the screw 10 is continued to be rotated, they are conveyed on the downstream side of the heating cylinder 201, and the molten resin M is accumulated closer to the downstream side than the screw 10 together with the reinforcing fibers F. The screw 10 is retreated by balance between a resin pressure of the molten resin M accumulated on the downstream of the screw 10 and the back pressure that suppresses the retreat of the screw 10. After that, the rotation and the retreat of the screw 10 are stopped at the time when an amount of the molten resin M required for one shot is accumulated (“plasticization completion” in FIG. 2B).

FIGS. 2A to 2C show states of the resin (the resin pellet P or the molten resin M) and the reinforcing fibers F by dividing the states into four stages of “unmolten resin”, “resin melting”, “fiber dispersion”, and “fiber dispersion completion”. In the stage of “plasticization completion”, the “fiber dispersion completion” closer to the downstream than the screw 10 shows the state where the reinforcing fibers F are dispersed in the molten resin M, and are subjected to injection, and the “fiber dispersion” shows that the fed reinforcing fibers F are dispersed in the molten resin M along with the rotation of the screw 10. In addition, the “resin melting” shows that the resin pellet P is gradually melted by receiving the shear force, and the “unmolten resin” shows the state where the insufficiently melted resin remains although the shear force is received, and shows that not all the resin has been melted. However, the reinforcing fibers F may be unevenly distributed in a region of the “fiber dispersion completion” in some cases.

### [Injection Process]

When the procedures enter the injection process, the screw 10 is advanced to a predetermined injection completion position as shown in FIG. 2C. At this time, the backflow prevention portion 30 included in a tip of the screw 10 is closed, thereby a pressure (an injection pressure) of the molten resin M accumulated closer to the downstream than the backflow prevention portion 30 rises, and the molten resin M is discharged toward the cavity from the discharge nozzle 203. The injection pressure reaches 200 MPa at the maximum.

After that, preceding one-cycle injection molding is completed through a holding process, a mold opening process, and a taking-out process, and a mold clamping process and the plasticizing process of a subsequent one cycle are performed in that order.

Here, in the embodiment, the third stage 23 is provided closer to the downstream side than the backflow prevention portion 30, and even if the screw 10 reaches the injection completion position, the resin accumulation region is formed closer to the downstream side than the backflow prevention portion 30, and the molten resin M having not been injected into the cavity occupies the resin accumulation region. An amount of the molten resin M that occupies the resin accumulation region (hereinafter, represented as molten resin Mr) is preferably not less than an amount corresponding to a resin amount for one shot in the subsequent molding cycle. In addition, the molten resin Mr is a target in which the reinforcing fibers F contained therein are opened as will be explained hereinafter.

### [Impregnation of Molten Resin and Dispersion of Reinforcing Fibers]

A high pressure is given to the molten resin Mr together with the molten resin M injected into the cavity during the injection process. The molten resin Mr contains the reinforcing fibers F, which can contain the reinforcing fibers F conveyed to the third stage 23 in a massive state. However, during the injection process in the embodiment, a strong compressive force σ based on the injection pressure is isotropically given to the molten resin Mr that surrounds the reinforcing fibers F in the massive state as shown in FIG. 3B. An inside of the reinforcing fibers F is impregnated with the molten resin Mr by the isotropic compressive force σ. Hereby, since the reinforcing fibers F are made to adhere to each other by the molten resin Mr in an inside of the massive reinforcing fibers F, or the inside of the massive reinforcing fibers F is filled with the molten resin Mr as a transmission medium of the force, the force applied from an outside of the massive reinforcing fibers F can be transmitted to the inside without disappearing near a surface layer of the massive reinforcing fibers F by slippage between the reinforcing fibers F.

When a shear force is given to the molten resin Mr after resin impregnation is achieved as described above, the shear force is transmitted through the molten resin Mr with which the reinforcing fibers F have been impregnated, and reaches the inside of the massive reinforcing fibers F, and thus opening of the reinforcing fibers F is promoted. In order to achieve this, in the embodiment, if the injection process is completed, the shear giving shaft 23A of the third stage 23 is rotated together with the screw 10, and thereby a swirling flow is generated in the molten resin Mr around the shear giving shaft 23A. In that case, as shown in FIG. 3C, as a result of a shear force τ being given to the molten resin Mr, opening of the reinforcing fibers F proceeds, and the reinforcing fibers F are dispersed in the molten resin Mr. In a manner as described above, the molten resin Mr in which the opening and dispersion of the reinforcing fibers F have proceeded is used as a target for subsequent-cycle injection.

If the above treatment of the opening and dispersion of the reinforcing fibers F is ended, the plasticizing unit 200 moves to the plasticizing process preparing for the next-cycle injection molding.

Here, rotation of the third stage 23 (the screw 10) can be covered by rotation in the plasticizing process of the subsequent cycle. That is, according to the embodiment, impregnation of the molten resin Mr and giving of the shear force τ can be performed during the processes necessary for injection molding.

### [Effects of the Embodiment]

As explained above, in the embodiment, the high compressive force σ is given to the molten resin Mr to thereby make the massive reinforcing fibers F impregnated with the molten resin Mr, and subsequently, the shear force τ is given to the molten resin Mr to thereby promote the opening and dispersion of the reinforcing fibers F.

Accordingly, the reinforcing fibers F are uniformly dispersed in molded products obtained by the embodiment.

In addition to that, since the inside of the massive reinforcing fibers F is impregnated with the molten resin Mr, the reinforcing fibers F can be opened and dispersed even though the shear force τ to be given is suppressed to be small. Consequently, since fracture of the reinforcing fibers F is suppressed to the minimum in the obtained molded products, desired strength can be easily obtained.

Further, since impregnation of the molten resin Mr into the massive reinforcing fibers F is performed during the injection process, a new process for impregnation need not be added. In addition, since giving of the shear force is performed during the plasticizing process of the next cycle, the new process for impregnation need not be added, either. Consequently, according to the embodiment, the molded products in which the reinforcing fibers F have been uniformly dispersed can be obtained without increasing a cycle time of injection molding.

Hereinbefore, although the present invention has been explained based on the embodiment, it is possible to select a configuration exemplified in the above-described embodiment or to appropriately change the configuration to the other configuration, unless the configuration departs from the spirit of the present invention.

First, a cross-sectional shape of the shear giving shaft 23A is not limited to a circle, and may be any of an oval (except for the circle), polygonal shapes (a triangle, a quadrangle, etc.), and an indefinite shape.

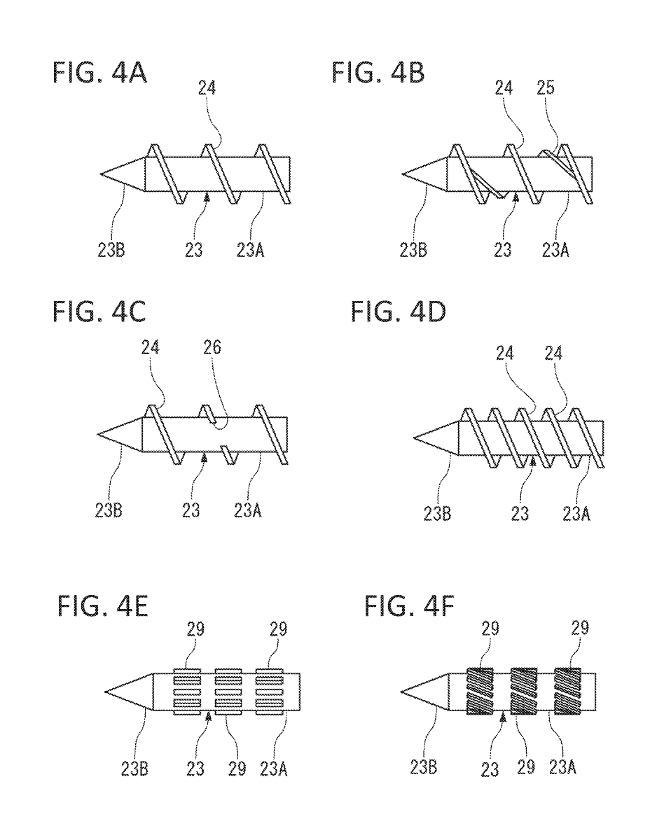

In addition, a portion that projects in the radial direction can be provided around the shear giving shaft 23A. By providing a projecting portion, an effect to stir the molten resin Mr around the shear giving shaft 23A can be increased by rotating it. Several examples of the projecting portion are shown in FIGS. 4A to 4F.

FIG. 4A shows the example in which a flight 24 including a spiral projecting portion has been provided around the shear giving shaft 23A. Since the flight 24 includes a lead, capability to convey the molten resin M or raise a pressure of the molten resin M can be given in the third stage 23, and thus the molten resin M can be stably conveyed even though the back pressure is large.

A mode of the flight is not limited to a mode of FIG. 4A, and for example, modes shown in FIGS. 4B to 4D can also be employed.

FIG. 4B shows the example in which the flight 24 is regarded as a so-called main flight 24, and in which a sub-flight 25 is provided to the main flight 24. An outer diameter of the sub-flight 25 is set to be smaller than that of the main flight 24. At this time, both ends of the sub-flight 25 are preferably blocked to the main flight 24. While the molten resin M leaks from a gap (gaps) between the end(s) and the main flight 24 when both ends or one end of the sub-flight 25 are (is) separated from the main flight 24, the molten resin M can flow over all top portions of the sub-flights 25 to give the shear force if the gap(s) are (is) blocked.

In the example shown in FIG. 4C, a notch 26 is partially provided, and the flight 24 is intermittently provided. When the notch 26 is provided, a shear force can be generated between a center portion and both-side portions of the center portion of the screw groove in a width direction, and thus opening of the reinforcing fibers F can be promoted.

The example shown in FIG. 4D corresponds to a two-thread flight in which two flights 24 with the same specification have been provided.

In FIG. 4E, projecting portions are formed with fins 29 that extend along an axial direction of the shear giving shaft 23A, each shape of the fins 29 being a rectangle in a planar view. The fins 29 are provided at a plurality of stages (three stages here) in the axial direction, and in each stage, the plurality of fins 29 are provided side by side in a peripheral direction with a predetermined interval therebetween.

The fins 29 are not limited to the example of extending along the axial direction, and they can also be provided so as to be perpendicular in the axial direction as shown in FIG. 4F. Since a conveyance force of the molten resin Mr can be given to the fins by giving an inclination (a lead) to the fins, resin conveyance resistance in the shear giving shaft 23A can be reduced.

Although the number of the fins 29 belonging to each stage is set to be equal in the examples shown in FIGS. 4E and 4F, the number of the fins 29 can be increased from the stage of the upstream side toward the stage of the downstream side.

In addition, in the above embodiment, the method has been explained for feeding the resin pellet P on the upstream side, and feeding the reinforcing fibers F on the downstream side. However, it is obvious that without limiting to the method, the present invention can be achieved in which the high compressive force σ is given to the molten resin Mr to thereby make the massive reinforcing fibers F impregnated with the molten resin Mr, and in which subsequently, the shear force τ is given to the molten resin Mr to thereby promote the opening and dispersion of the reinforcing fibers F. That is, the present invention can be applied to various methods for obtaining fiber reinforced resin by injection molding.

In the plasticizing unit 200 of the present invention, although the fiber feed device 213 and the resin feed hopper 207 are fixed to the heating cylinder 201, a movable hopper that moves in the axial direction of the screw 10 can be employed. Particularly in a case where a multiaxial type measurement feeder is used for the fiber feed device 213, a plurality of feeders may be coupled and arranged in parallel in the longitudinal direction of the screw 10, and the feeders that feed the reinforcing fibers F in the plasticizing process may be switched and used. Specifically, the reinforcing fibers F are fed from the feeder arranged at the tip side of the screw 10 at the time of start of the plasticizing process, and along with the retreat of the screw 10 in the plasticizing process, the feeder that feeds the reinforcing fibers F may be switched to the feeders of the back side one after the other so that a relative position of the screw 10 and a feeder screw from which the fibers are discharged is not changed. Hereby, a feed position of the reinforcing fibers F relative to the screw 10 can be set to be constant regardless of the change of the relative position of the heating cylinder 201 and the screw 10 due to the retreat of the screw 10 and the advance of the screw 10 at the time of injection.

Specifically, since a position of the fiber feed feeder screw at the time of plasticization completion, i.e. a position of the backmost screw groove filled with the reinforcing fibers F, can be made coincide with a position of the fiber feed feeder screw at the time of next plasticization start in a position of the screw advanced by the injection, the reinforcing fibers F can be continuously fed to the screw groove located closer to the downstream than the fiber feed device 213, and it is effective for preventing or suppressing generation of a region not filled with the reinforcing fibers F, the region being located in the groove of the screw 10 closer to the downstream than the fiber feed device 213.

In addition, as a way of switching the feeder screws, mere ON/OFF control may be performed, or the number of rotation of adjacent screw feeders may be changed in cooperation. Specifically, the number of rotation of the screw feeders of the downstream side is gradually reduced along with the retreat of the screw, and the number of rotation of the screw feeders of the back side may be increased gradually.

In addition, feed of the reinforcing fibers F to the heating cylinder 201 may be performed not only in the injection process and the plasticizing process, but may also be, for example, performed in a dwelling process and an injection standby process (a period from completion of the plasticizing process to start of the injection process). Since the screw 10 does not perform rotation, and advance or retreat during the dwelling process and the injection standby process, the vent hole is not intermittently blocked by movement of the flights. For this reason, the reinforcing fibers can be stably fed in the groove of the screw 10.

In addition, not only the reinforcing fibers F but the reinforcing fibers F with which powdery or pellet-type raw resin has been mixed may be fed to the fiber feed device 213. In this case, even though the molten resin M cannot easily infiltrate between the reinforcing fibers F, the mixed raw resin is melted in the mass of the reinforcing fibers F, enters the inside of the fiber bundle, and can promote loosening of the fiber bundle.

In addition, resin and reinforcing fibers applied to the present invention are not particularly limited, and well-known materials are widely encompassed, such as: general-purpose resin, such as polypropylene and polyethylene; well-known resin such as engineering plastics, such as polyamide and polycarbonate; and well-known reinforcing fibers, such as glass fibers, carbon fibers, bamboo fibers, and hemp fibers. Note that in order to more remarkably obtain the effects of the present invention, fiber reinforced resin with a high content rate of reinforcing fibers, i.e. a content rate not less than 10%, is preferably employed as a target. However, when the content rate of the reinforcing fibers exceeds 60%, density of a resin mass is high, and thus there is increased a possibility that a whole region of the fibers is not sufficiently impregnated with the molten resin even though the injection pressure is added, the fibers being in a region corresponding to the shear giving shaft. For this reason, the content rate of the reinforcing fibers applied to the present invention is preferably 10 to 60%, and is more preferably 15 to 50%.

### REFERENCE SIGNS LIST

1 injection molding machine
10 screw
21 first stage
21A feed portion
21B compression portion
22 second stage
22A feed portion
22B compression portion
23 third stage
23A shear giving shaft
23B screw chip
24 flight, main flight
25 sub-flight
26 notch
27 first flight
28 second flight
29 fin
30 backflow prevention portion
31 check ring
33 coupling shaft
35 second sheet ring
37 first sheet ring
38 flow passage
50 control unit
100 mold clamping unit
101 base frame
103 fixed mold
105 fixed die plate
107 slide member
109 movable mold
111 movable die plate
113 hydraulic cylinder
115 tie bar
117 hydraulic cylinder
119 ram
121 male screw portion
123 half nut
200 plasticizing unit
201 heating cylinder
203 discharge nozzle
206 vent hole
207 resin feed hopper
208 feed hole
209 first electric motor
211 second electric motor
213 fiber feed device
214 biaxial type screw feeder
215 pellet feed device
218 roving cutter
300 screw
301 screw groove
303 pull side
305 push side
306 flight
310 cylinder
F reinforcing fibers
M and Mr molten resin
P resin pellet

1-7. (canceled)

8. An injection molding method of fiber reinforced resin that repeats:
a plasticizing process of feeding a resin raw material and reinforcing fibers to a cylinder inside which a screw is provided, melting the resin raw material by rotating the screw, and generating molten resin containing the reinforcing fibers; and
an injection process of discharging from the cylinder a predetermined amount of the molten resin containing the reinforcing fibers by advancing the screw to a predetermined injection completion position to give a predetermined injection pressure, wherein
a resin accumulation region is provided in a region to which the injection pressure inside the cylinder is applied, the resin accumulation region in which the molten resin not less than an amount corresponding to a resin amount for one shot in a subsequent molding cycle is accumulated, the resin accumulation region being formed in a downstream side of the screw in a space between an outside surface of a shear giving shaft and an inside surface of the cylinder, the shear giving shaft being provided integrally with the screw,
in the injection process of a preceding cycle, the injection pressure is given to the molten resin that occupies the resin accumulation region, and
in the plasticizing process of a subsequent cycle, a shear force is given to the molten resin that occupies the resin accumulation region.

9. The injection molding method according to claim 8, wherein the reinforcing fibers are fed to the cylinder closer to a downstream side than the resin raw material.

10. The injection molding method according to claim 8, wherein the shear force in the plasticizing process of the subsequent cycle is given by a shear giving shaft rotating along with rotation of the screw, the shear giving shaft being provided coaxially with the screw and extending in the resin accumulation region.

11. The injection molding method according to claim 8, wherein
the screw includes: a first stage at which the fed resin raw material is melted; a second stage continuing to the first stage, and at which the melted resin raw material and the reinforcing fibers are mixed with each other; and a third stage that continues to the second stage through a backflow prevention portion, and
the third stage includes a shear giving shaft that gives a shear force to the molten resin that occupies the resin accumulation region by rotating along with the rotation of the screw.

12. The injection molding method according to claim 8, wherein the shear giving shaft of the third stage includes one or both of a spiral flight that projects in a radial direction from an outer peripheral surface, and a mixing at which a plurality of fins that project in a radial direction from an outer peripheral surface have been aligned in a peripheral direction.

13. A screw provided inside a cylinder of an injection molding machine to which a resin raw material is fed on an upstream side and to which reinforcing fibers are fed on a downstream side, the screw comprising:
a first stage at which the resin raw material to be fed is melted;
a second stage that continues to the first stage, and at which the melted resin raw material and the fed reinforcing fibers are mixed with each other; and
a third stage that continues to the second stage through a backflow prevention portion, and includes a shear giving shaft that gives a shear force to the molten resin that occupies surroundings of the screw by rotating along with rotation of the screw,
wherein, when a volume between an inside surface of the cylinder and an outside surface of the shear giving shaft is V, a cross-sectional area in an inner diameter of the cylinder is S, and a length of the second stage is L, the volume V is set so as to satisfy a relation of the following Expression (1).
V=( 1/20)×L×S to (½)×L×S (1)

14. An injection molding machine of fiber reinforced resin, comprising:
a cylinder at which a discharge nozzle has been formed;
a screw provided to be rotatable and movable in a rotation axis direction inside the cylinder;
a resin feed portion that feeds a resin raw material in the cylinder; and
a fiber feed portion that is provided closer to a downstream side than the resin feed portion, and feeds reinforcing fibers in the cylinder, wherein
the screw includes:
a first stage at which the resin raw material to be fed is melted;
a second stage that continues to the first stage, and at which the melted resin raw material and the fed reinforcing fibers are mixed with each other; and
a third stage that continues to the second stage through a backflow prevention portion, and includes a shear giving shaft that gives a shear force to the molten resin that occupies surroundings of the screw by rotating along with rotation of the screw,
wherein, when a volume between an inside surface of the cylinder and an outside surface of the shear giving shaft is V, a cross-sectional area in an inner diameter of the cylinder is S, and a length of the second stage is L, the volume V is set so as to satisfy a relation of the following Expression (1).
V=( 1/20)×L×S to (½)×L×S (1)
